(19) United States
(12) Patent Application Publication
(10) Pub. No.: US 2016/0053478 A1
(43) Pub. Date: Feb. 25, 2016

(54) Interlocking Clip System

(71) Applicant: Charles Porter, Blythewood, SC (US)

(72) Inventor: Charles Porter, Blythewood, SC (US)

(21) Appl. No.: 14/804,961

(22) Filed: Jul. 21, 2015

Related U.S. Application Data
(60) Provisional application No. 62/038,927, filed on Aug. 19, 2014.

(51) Int. Cl. E04B 1/41; F16B 5/06; F16B 5/02

(52) U.S. Cl. CPC E04B 1/40; F16B 5/0208; F16B 5/0642; E04B 2001/405

(57) ABSTRACT

A first clip and a second clip each having a housing including a top and bottom wall interconnected by side walls defining a hollow interior socket, a connector insert carried in the socket including a base portion having a series of laterally spaced prongs extending parallel with the length of the socket, the prongs having a distal end portion extending outward beyond the housing; the distal end portions of the prongs on the first clip are adapted for engaging the prongs of the second clip in interlocking engagement; the distal end portions of the prongs on the first clip are received into the socket of the second clip, and the distal end portions of the prongs on the second clip are received into the socket of the first clip so that the housing of the first clip is disposed flush against the housing of the second clip to resist movement.

### BACKGROUND OF THE INVENTION

1) Field of the Invention

The present invention relates to mounting hardware for hanging items on walls, and more particularly, to an interlocking clip system for removably mounting items, such as paneling, on a wall.

2) Description of Related Art

Wall paneling is a popular wall covering but can be problematic to install because it must be properly aligned, securely mounted, the front surface must remain intact, it is often heavy, and it is difficult to work with because the panels are typically large and cumbersome.

Some installations of wall paneling are achieved by directly adhering a panel to a wall using an adhesive. This is undesirable because it does not accommodate for panel movement due to expansion and contraction, and can damage the panels if removal is required.

The prior art is replete with various connectors for hanging panels on a wall surface. However, a common problem among connectors in ensuring that the cooperating elements of traditional hanging hardware have fully engaged behind a wall panel so that the installer is sure the panel is properly installed and secured.

Further, another common problem with connectors for mounting wall panels is that they may be to easily dislodged, allowing the panel to separate from the wall and potential fall, such as during an earthquake event.

Another problem with existing connectors in the prior art is that they are largely insufficient for mounting panels in a horizontal plane, such as when attaching to a ceiling. The connectors as simply not designed to handle the types of loads exerted in such a mounting arrangement. More robust and secure mounting means are needed when attempting to mount paneling to a ceiling.

Accordingly, it is an object of the present invention to provide an interlocking clip system that is simple, strong, and precise, yet still allows for the movement of panels after installation to accommodate for expansion and contraction of the panel materials.

It is a further object of the present invention to provide an interlocking clip system that is configured to securely hold the wall panel on a base wall surface in a removable manner.

It is a further object of the present invention to provide an interlocking clip system that is able to securely hold wall panels in a horizontal mounting arrangement.

It is a further object of the present invention to provide an interlocking clip system that will not lock into position unless the clips are fully engaged and connected to confirm proper installation for an installer.

### SUMMARY OF THE INVENTION

The above objectives are accomplished according to the present invention by providing a clip for an interlocking clip system, the clip comprising a housing having a top wall and bottom wall interconnected by a first side wall and a second side wall defining a hollow interior socket; a connector insert carried in the socket; a base portion included in the connector insert having a shape complementary to the socket so that the base portion engages the top, bottom and side walls of the housing; a series of laterally spaced prongs extending from the base portion parallel with the length of the socket, wherein each of the prongs has a distal end portion extending outward beyond the housing; and, wherein the distal end portions of the prongs are adapted for engaging a complementary set of prongs from a second the clip in interlocking engagement.

In one embodiment, the clip includes a mounting opening disposed in each of the top wall and bottom wall of the housing, and the base portion of the connector insert; wherein each mounting opening in the walls and base portion is aligned to provide a continuous passage for receiving a securing member extending through the housing and connector insert for mounting the clip to a surface and securing the connector insert in the socket.

In one embodiment, the clip includes a connecting tooth disposed on the distal end portion of each the prong of the connector insert, wherein each connecting tooth extends laterally perpendicular to the length of the prong and is adapted to engage a complementary connecting tooth of the second said clip for interlocking engagement.

In one embodiment, each connecting tooth is defined by a first angled engaging surface extending from a tip of the prong, and a second angled engaging surface extending from an end of the first angled engaging surface opposite the tip to a side of the prong such that the connecting tooth has a triangular shape.

In one embodiment, the prong is flexed laterally when the first angled engaging surface engages a complementary first angled engaging surface of a connecting tooth on the second said clip.

In one embodiment, the second angled engaging surface engages a complementary second angled engaging surface of a connecting tooth on the second said clip so that opposing prongs between the clips are interlocked.

In one embodiment, the clip includes a series of five laterally spaced prongs extending from the base portion of the connector insert.

In one embodiment, the clip has a first prong including a connecting tooth that extends facing a second prong, the second prong includes a connecting tooth that extends facing the first prong, a third prong includes a connecting tooth that extends facing a forth prong, and the forth prong includes a connecting tooth that extends facing the third prong, and a fifth prong includes a connecting tooth that extends facing away from the forth prong.

In one embodiment, the top and bottom walls of the housing are disposed adjacent the prongs so that movement of the prongs along an axis perpendicular to the plane of the top and bottom walls is restricted.

In one embodiment, the side walls are spaced from the prongs so that the prongs are free to flex laterally between the side walls when engaging the complementary set of prongs from the second said clip.

In one embodiment, the socket extends entirely through the housing and is open at opposite ends.

The above objectives are further accomplished according to the present invention by providing an interlocking clip system, comprising a first clip and a second clip each having a housing including a top wall and bottom wall interconnected by a first side wall and a second side wall defining a hollow interior socket, a connector insert carried in the socket including a base portion having a series of laterally spaced prongs extending from the base portion parallel with the length of the socket, wherein each of the prongs has a distal end portion extending outward beyond the housing; wherein the distal end portions of the prongs on the first clip are adapted for engaging the prongs of the second clip in interlocking engagement; and, wherein the distal end portions of the prongs on the first clip are received into the socket of the second clip, and the distal end portions of the prongs on the second clip are received into the socket of the first clip so that the housing of the first clip is disposed flush against the housing of the second clip to resist movement between the first and second clips when interconnected.

In one embodiment, the interlocking clip system includes a connecting tooth disposed on the distal end portion of each the prong of the connector insert, wherein each connecting tooth extends laterally perpendicular to the length of the prong so that the connecting teeth of the first and second clips cooperate in interlocking engagement.

In one embodiment, each connecting tooth is defined by a first angled engaging surface extending from a tip of the prong, and a second angled engaging surface extending from an end of the first angled engaging surface opposite the tip to a side of the prong such that the connecting tooth has a triangular shape.

In one embodiment, the prongs are flexed laterally when the first angled engaging surfaces of the connecting teeth between the first and second clips engage when being interconnected.

In one embodiment, the second angled engaging surfaces of the connecting teeth of the first and second clips engage so that opposing prongs between the clips are interlocked.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1A shows a perspective view of a first clip and a second clip arranged for interlocking engagement according to the present invention;

FIG. 1B shows an exploded perspective view of the first and second interlocking clips according to the present invention;

FIGS. 2A-2C show various engagement stages of the first clip engaging the second clip in interlocking engagement according to the present invention; and,

FIG. 3 shows a perspective cut-away of the clips mounting a finished wall panel to a base wall surface.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to specific embodiments, it will be appreciated that the description is illustrative of the invention and is not constructed as limiting of the invention.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

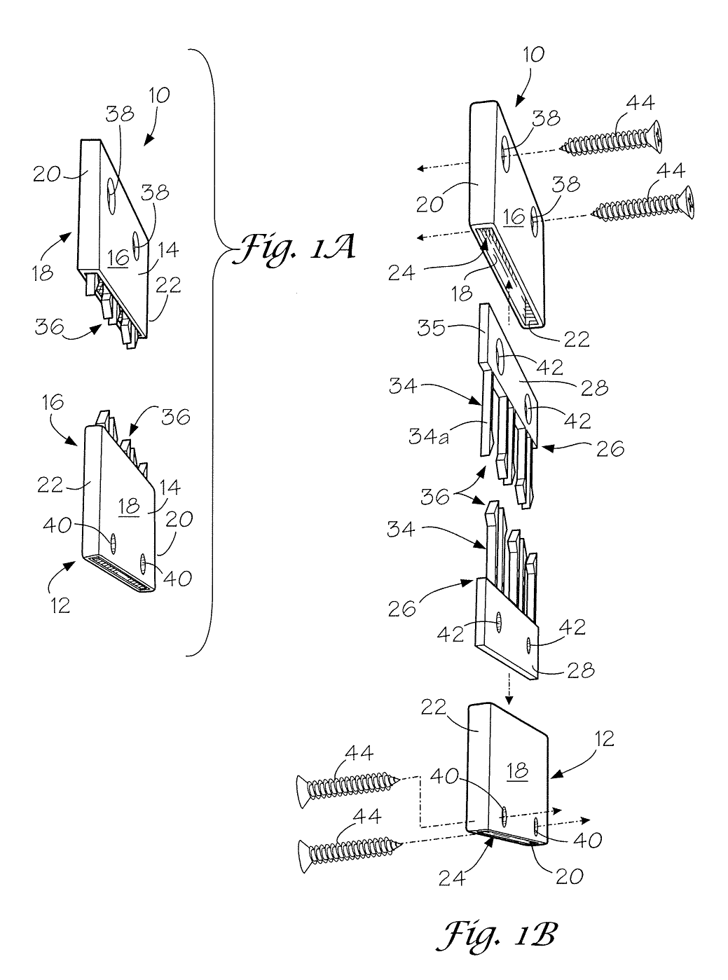

Referring to FIGS. 1A-1B, a first clip 10 is shown in an arrangement for engaging with a second clip 12 to interlock the clips together. Two identical clips cooperate in interlocking engagement by flipping one of the two clips over so that a series of prongs 34 extending from the clips are arranged to engage in a complementary interlocking arrangement. The first and second clips 10, 12 are accordingly identical in construction in the illustrated embodiment.

Referring to FIGS. 1A-1B, the clips are illustrated so that a top wall 16 of first clip 10 is shown, and a bottom wall 18 of second clip 12 is shown. Accordingly, in the illustrated embodiment, second clip 12 is flipped over so that bottom wall 18 is generally aligned in a common plane with top wall 16 for interconnecting first and second clips 10, 12 as detailed herein below.

In the illustrated embodiment, each of first and second clips 10, 12 include a housing, designated generally as 14. Housing 14 includes top wall 16 and bottom wall 18 interconnected by a first side wall 20 and a second side wall 22.

Referring to FIG. 1B, walls 16, 18, 20, and 22 of housing 14 combine to define a hollow interior socket, designated generally as 24. In the illustrated embodiment, socket 24 extends entirely through housing 14 and is open at opposite ends. This arrangement reduces manufacturing costs and reduces the overall weight of housing 14, as opposed to adding a third side wall to close in socket 24. Addition of a third wall is an embodiment contemplated for the present invention.

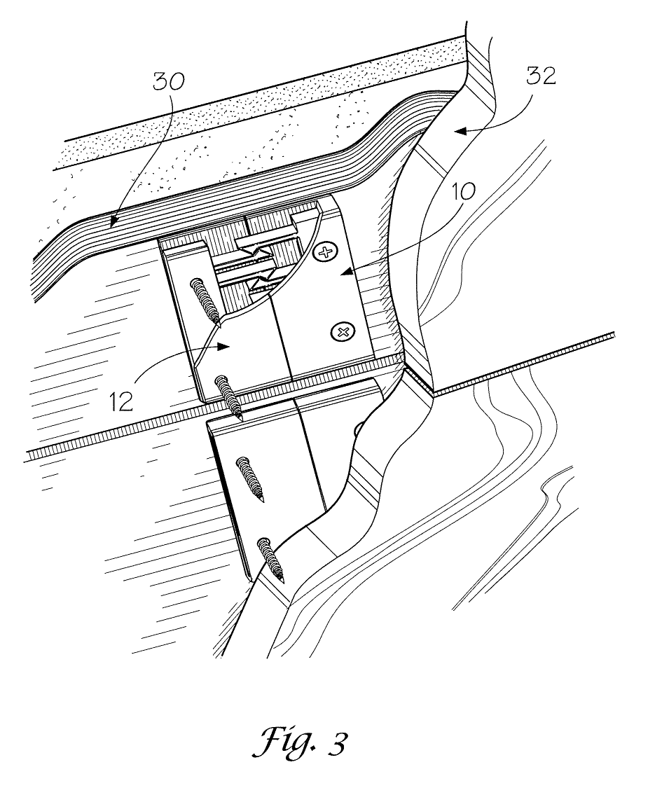

With further reference to FIG. 3, housing 14 is preferably constructed and arranged to have an oblong rectangular shape that provides a thin profile for mounting against walls and the like to reduce panel gaps between a base surface 30 and a finishing panel 32.

Referring to FIG. 1B, a connector insert, designated generally as 26, is carried in socket 24 that provides the connectivity between first and second clips 10, 12. Connector insert 26 includes a base portion 28 having a shape complementary to socket 24 so that base portion 28 engages top, bottom and side walls 16, 18, 20 and 22 of housing 14 to prevent movement of base portion 28 in socket 24.

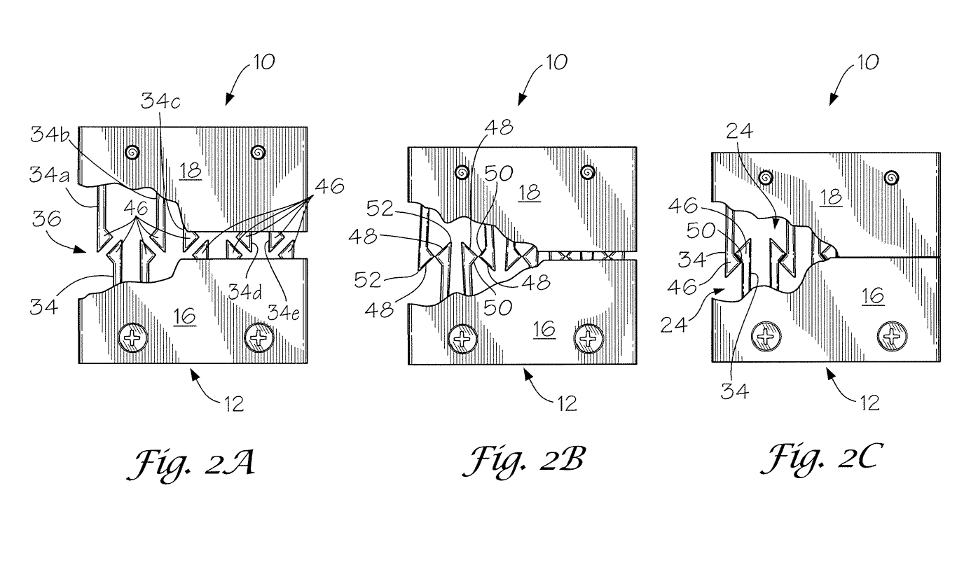

Referring to FIG. 1B, a series of laterally spaced prongs, designated generally as 34, extend from base portion 28 parallel with the length of socket 24. Referring to FIG. 1A, each of prongs 34 has a distal end portion 36 extending outward beyond a distal edge of housing 14. Referring to FIGS. 2A-2C and 3, distal end portions 36 of prongs 34 on first clip 10 are adapted for engaging a complementary set of prongs 34 from second clip 12 in interlocking engagement.

Referring to FIG. 1B, in the illustrated embodiment, a pair of mounting openings 38 are disposed in top wall 16 of housing 14. A second set of mounting openings 40 are disposed in bottom wall 18 housing 14. A third set of mounting openings 42 are disposed in base portion 28 of connector insert 26. The mounting openings 38, 30, 42 in walls 16, 18 and base portion 28 are aligned to provide continuous passages for receiving a securing member 44. In the illustrated embodiment, securing member 44 is constructed and arranged to extend through the continuous passages provided by alignment of mounting openings 38, 40, 42 in housing 14 and connector insert 26 for mounting clips 10, 12 to a surface, such as base wall surface 30 or finishing wall panel 32 (FIG. 3). Further, securing member 44 secures connector insert 26 in socket 24.

Referring to FIGS. 2A-2C, a connecting tooth 46 is disposed on distal end portion 36 of each prong 34 of connector insert 26. Each connecting tooth 46 extends laterally perpendicular to the length of prong 34 and is adapted to engage an identical complementary connecting tooth 46 of a second clip for interlocking engagement. In the illustrated embodiment, each connecting tooth 46 is defined by a first angled engaging surface 48 extending from a tip 52 of prong 34, and a second angled engaging surface 50 extending from an end of first angled engaging surface 48 opposite tip 52 to a side of prong 34 such that connecting tooth 46 has a triangular shape.

Referring to FIG. 2B, when interconnecting first clip 10 with second clip 12, prongs 34 are flexed laterally toward side walls 20, 22 when first angled engaging surface 48 engages a complementary first angled engaging surface 48 of a connecting tooth 46 on the opposing clip. With further reference to FIG. 1B, first and second side walls 20, 22 are spaced from the outer most prongs 34 on opposite ends of base portion 28 so that prongs 34 are free to flex laterally between side walls 20, 22 when engaging a complementary set of prongs from the opposing clip. In the illustrated embodiment, prong 34a is set back from edge 35 of base portion 28 at least the distance that prong 34a is deflected when first angled engaging surfaces 48 of opposing prongs 34 engage. Accordingly, there is thus sufficient lateral movement without interference from sidewalls 20, 22.

Referring to FIG. 1A, in a preferred embodiment, top and bottom walls 16, 18 of housing 14 are disposed adjacent prongs 34 so that movement of prongs 34 along an axis perpendicular to the plane of top and bottom walls 16, 18 is restricted. Accordingly, prongs 34 are only flexible toward side walls 20, 22 for lateral displacement when engaging complementary prongs from an opposing clip.

Referring to FIG. 2C, when prongs 34 between first clip 10 and second clip 12 are fully engaged and interconnected, second angled engaging surface 50 of first clip 10 engages a complementary second angled engaging surface 50 of a connecting tooth 46 on second clip 12 so that opposing prongs between clips 10, 12 are interlocked. Further, in the illustrated embodiment, distal end portions 36 of prongs 34 on first clip 10 are received into socket 24 of second clip 12. Likewise, distal end portions 36 of prongs 34 on second clip 12 are received into socket 24 of first clip 10 so that housing 14 of first clip 10 is disposed flush against housing 14 of second clip 12 to resist movement between first and second clips 10, 12 when interconnected. Preferably, prongs 34 are sufficiently ridged to require a minimum of 5 pound pull weight to cause separation of the prongs and disengagement between first and second clips 10, 12.

Referring to FIG. 2A, in a preferred embodiment, a series of five laterally spaced prongs 34 extending from base portion 28 of connector insert 26. Prongs 34 are constructed and arranged to include a first prong 34a including a connecting tooth 46 that extends facing a second prong 34b. Second prong 34b includes a connecting tooth 46 that extends facing first prong 34a. A third prong 34c includes a connecting tooth 46 that extends facing a forth prong 34d. Forth prong 34d includes a connecting tooth 46 that extends facing third prong 34c. Finally, a fifth prong 34e includes a connecting tooth 46 that extends facing away from forth prong 34d. Accordingly by flipping one of clips 10, 12 over to engage the other, the prongs align in a complementary engaging manner that allows first clip 10 to be mounted to a base wall surface 30, and second clip 12 to be mounted to a finishing wall panel 32 (FIG. 3) so that the two can be interlocked for hanging the finishing wall pane 32 on the base wall surface 30.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. A clip for an interlocking clip system, said clip comprising:
a housing having a top wall and bottom wall interconnected by a first side wall and a second side wall defining a hollow interior socket;
a connector insert carried in said socket;
a base portion included in said connector insert having a shape complementary to said socket so that said base portion engages said top, bottom and side walls of said housing;
a series of laterally spaced prongs extending from said base portion parallel with the length of said socket, wherein each of said prongs has a distal end portion extending outward beyond said housing; and,
wherein said distal end portions of said prongs are adapted for engaging a complementary set of prongs from a second said clip in interlocking engagement.

2. The clip of claim 1 including a mounting opening disposed in each of said top wall and bottom wall of said housing, and said base portion of said connector insert;
wherein each said mounting opening in said walls and base portion is aligned to provide a continuous passage for receiving a securing member extending through said housing and connector insert for mounting said clip to a surface and securing said connector insert in said socket.

3. The clip of claim 1 including a connecting tooth disposed on said distal end portion of each said prong of said connector insert, wherein each said connecting tooth extends laterally perpendicular to the length of said prong and is adapted to engage a complementary connecting tooth of the second said clip for interlocking engagement.

4. The clip of claim 3 wherein each said connecting tooth is defined by a first angled engaging surface extending from a tip of said prong, and a second angled engaging surface extending from an end of said first angled engaging surface opposite said tip to a side of said prong such that said connecting tooth has a triangular shape.

5. The clip of claim 4 wherein said prong is flexed laterally when said first angled engaging surface engages a complementary first angled engaging surface of a connecting tooth on the second said clip.

6. The clip of claim 4 wherein said second angled engaging surface engages a complementary second angled engaging surface of a connecting tooth on the second said clip so that opposing prongs between said clips are interlocked.

7. The clip of claim 3 including a series of five laterally spaced prongs extending from said base portion of said connector insert.

8. The clip of claim 7 wherein a first prong includes a connecting tooth that extends facing a second prong, said second prong includes a connecting tooth that extends facing said first prong, a third prong includes a connecting tooth that extends facing a forth prong, and said forth prong includes a connecting tooth that extends facing said third prong, and a fifth prong includes a connecting tooth that extends facing away from said forth prong.

9. The clip of claim 1 wherein said top and bottom walls of said housing are disposed adjacent said prongs so that movement of said prongs along an axis perpendicular to the plane of said top and bottom walls is restricted.

10. The clip of claim 1 wherein said side walls are spaced from said prongs so that said prongs are free to flex laterally between said side walls when engaging said complementary set of prongs from the second said clip.

11. The clip of claim 1 wherein said socket extends entirely through said housing and is open at opposite ends.

12. An interlocking clip system, comprising:
a first clip and a second clip each having a housing including a top wall and bottom wall interconnected by a first side wall and a second side wall defining a hollow interior socket, a connector insert carried in said socket including a base portion having a series of laterally spaced prongs extending from said base portion parallel with the length of said socket, wherein each of said prongs has a distal end portion extending outward beyond said housing;
wherein said distal end portions of said prongs on said first clip are adapted for engaging said prongs of said second clip in interlocking engagement; and,
wherein said distal end portions of said prongs on said first clip are received into said socket of said second clip, and said distal end portions of said prongs on said second clip are received into said socket of said first clip so that said housing of said first clip is disposed flush against said housing of said second clip to resist movement between said first and second clips when interconnected.

13. The interlocking clip system of claim 12 wherein said base portion has a shape complementary to said socket so that said base portion engages said top, bottom and side walls of said housing to resist movement of said base portion in said socket.

14. The interlocking clip system of claim 12 including a mounting opening disposed in each of said top wall and bottom wall of said housing, and said base portion of said connector insert; wherein each said mounting opening in said walls and base portion is aligned to provide a continuous passage for receiving a securing member extending through said housing and connector insert for mounting said clips to a surface and securing said connector insert in said socket.

15. The interlocking clip system of claim 12 including a connecting tooth disposed on said distal end portion of each said prong of said connector insert, wherein each said connecting tooth extends laterally perpendicular to the length of said prong so that the connecting teeth of said first and second clips cooperate in interlocking engagement.

16. The interlocking clip system of claim 15 wherein each said connecting tooth is defined by a first angled engaging surface extending from a tip of said prong, and a second angled engaging surface extending from an end of said first angled engaging surface opposite said tip to a side of said prong such that said connecting tooth has a triangular shape.

17. The interlocking clip system of claim 16 wherein said prongs are flexed laterally when said first angled engaging surfaces of the connecting teeth between said first and second clips engage when being interconnected.

18. The interlocking clip system of claim 16 wherein said second angled engaging surfaces of the connecting teeth of said first and second clips engage so that opposing prongs between said clips are interlocked.

19. The interlocking clip system of claim 12 wherein said top and bottom walls of said housing are disposed adjacent said prongs so that movement of said prongs along an axis perpendicular to the plane of said top and bottom walls is restricted.

20. The interlocking clip system of claim 12 wherein said side walls are spaced from said prongs so that said prongs are free to flex laterally between said side walls when said first and second clips are being interlocked.
